(19) United States
(12) Patent Application Publication
(10) Pub. No.: US 2015/0051821 A1
(43) Pub. Date: Feb. 19, 2015

(54) METHOD OF CONTROLLING A TANDEM SOLENOID STARTER

(71) Applicant: GM GLOBAL TECHNOLOGY OPERATIONS LLC, Detroit, MI (US)

(72) Inventor: Matteo Presot, Torino (IT)

(21) Appl. No.: 14/463,504

(22) Filed: Aug. 19, 2014

(30) Foreign Application Priority Data
Aug. 19, 2013 (GB) 1314791.3

(51) Int. Cl. F02N 11/08

(52) U.S. Cl. CPC F02N 11/0844; Y10S 903/905
USPC 701/113; 180/65.28; 903/905

(57) ABSTRACT

A method of controlling a tandem solenoid starter for an automotive system is disclosed. The automotive system includes an internal combustion engine and a controller. The controller is configured to automatically stop and start the internal combustion engine. If a start of the internal combustion engine is initiated and the engine speed is higher than zero, an engagement between a pinion of the tandem solenoid starter and an engine flywheel gear is operated on the basis of an estimation of the engine speed at the time of engagement. The engine speed estimation is a function of a current engine speed and a current angular position of a crankshaft of the engine.

### CROSS REFERENCE TO RELATED APPLICATION

This application claims priority to GB Patent Application No. 1314791.3 filed Aug. 19, 2013, which is incorporated herein by reference in its entirety.

### TECHNICAL FIELD

The present disclosure relates to a method of controlling a tandem solenoid starter in automotive system, with or without hybrid architecture, for stopping and starting the internal combustion engine. In particular, the method is configured to manage a driver “change of mind”, when he or she requests to restart the engine (so called, “autostart”) during an engine stop phase (“autostop”), in other words, while the engine speed is still higher than zero.

### BACKGROUND

It is known that modern automotive system are provided with a function to stop and start the engine, hereafter also denoted as Stop & Start or simply S/S. Such function, automatically, shuts down and restarts the internal combustion engine to reduce the amount of time the engine spends idling, thereby reducing fuel consumption and emissions. This is most advantageous for vehicles which spend significant amounts of time waiting at traffic lights or frequently come to a stop in traffic jams. This S/S feature is present in hybrid electric vehicles, but has also appeared in vehicles which lack a hybrid electric powertrain. For non-electric vehicles (called micro-hybrids), fuel economy gains from this technology are typically in the range of 5 to 10 percent. In case of vehicles provided with Stop & Start system, conventional starters cannot restart the engine while the engine is running down. For this application a special starter is provided, so called tandem solenoid starter (TSS).

A drawback of automotive system provided with an S/S feature is the following: if an engine start has been requested while the engine is not completely shut-off, in other words, if a change of mind request arises during an engine stop phase, it is necessary to crank-on the engine as soon as possible, by refueling and/or activating the starter motor.

The autostart time performances in case of normal engine start or in case of an engine start due to a driver change of mind must be the same. However, no control strategies are able to realize such autostart performances, without incurring problems, related to condition that, in case of speed-match, the difference between the engine speed and the starter motor speed would be less than 180 rpm and positive and without avoiding engagements between starter and engine during the engine back-rotation.

Therefore a need exists for a new method, which, by improving the control of a tandem solenoid starter, is able to perform an engine start in the same time condition independent on the fact that the engine start is a normal one or is required by a change of mind.

### SUMMARY

In accordance with the present disclosure, a method of controlling a tandem solenoid starter is provided which realizes as fast as possible an engine start, derived from a driver change of mind, based on the engagement speed prediction between the starter and the engine. In order to fulfill the speed engagement conditions, the present disclosure defines a reliable engine speed prediction in order to fulfill the speed engagement conditions.

An embodiment of the disclosure provides a method of controlling a tandem solenoid starter for an automotive system. The automotive system includes an internal combustion engine and a controller. The controller is configured to automatically stop and start the internal combustion engine. If a start of the internal combustion engine is initiated and the engine speed is higher than zero, an engagement between a pinion of the tandem solenoid starter and an engine flywheel gear is operated on the basis of an estimation of the engine speed at the time of engagement. The engine speed estimation is a function of a current engine speed and a current angular position of a crankshaft of the engine.

An apparatus is also disclosed for controlling a tandem solenoid starter for an automotive system. The apparatus includes means for operating an engagement between a pinion of the tandem solenoid starter and an engine flywheel gear on the basis of an estimation of the engine speed at the time of engagement. The engine speed estimation is a function of a current engine speed and a current angular position of a crankshaft of the engine.

An advantage of these embodiments is that by means of a correct estimation of the engagement speed between starter and engine, it is possible to ensure that the two strategies for the tandem solenoid starter to be engaged to the internal combustion engine can be safely operated. In fact, in case of speed-match, the method will ensure that the difference between the engine speed and the starter motor speed would be less than a certain threshold and positive. On the other side, in case of speed-pinion, the method will ensure that the pinion engagement would not occur during the engine back rotation.

According to another embodiment, the engine speed is estimated on the basis of an engine speed difference with respect to the current engine speed after a time threshold. The engine speed difference is a function of the current angular position of the engine crankshaft. The estimation is based on a resolution lower than 50 rpm. Means for operating an engagement between a pinion of the tandem solenoid starter and an engine flywheel gear are configured to perform the engine speed estimation on the basis of an engine speed difference with respect to the current engine speed after a time threshold, the engine speed difference being a function of the current angular position of the engine crankshaft, and wherein the estimation is based on a resolution lower than 50 rpm. An advantage of these embodiments is that the engine speed difference between the current engine speed and the engine speed at the time of engagement, being function of the angular position of the engine crankshaft, can be grouped in homogeneous zones and for each zone a proper strategy can be implemented. Moreover the estimation based on a resolution lower than 50 rpm provides an acceptable engine speed tolerance.

According to an aspect, if the engine speed difference is higher than a calibrated speed threshold, the estimation will decrease the engine speed more than the speed threshold. If the engine speed difference is lower than the speed threshold, the estimation will decrease the engine speed less than the speed threshold. Means for controlling an engagement between a pinion of the tandem solenoid starter and an engine flywheel gear are configured so that if the engine speed difference is higher than a calibrated speed threshold, the estimation will decrease the engine speed more than the speed threshold and if the engine speed difference is lower than the speed threshold, the estimation will decrease the engine speed less than the speed threshold. An advantage of this aspect is to easily distinguish the engine speed behavior, by using a speed threshold which defines two zones: a first zone where the engine speed will decrease more than the threshold value, and a second zone where the engine speed will decrease less than the threshold value.

According to a further aspect, the speed threshold is 70 rpm. Means for controlling an engagement between a pinion of the tandem solenoid starter and an engine flywheel gear are configured to operate with a speed threshold of 70 rpm. An advantage of this aspect is to define a speed threshold which defines an acceptable engine speed tolerance.

According to a still further aspect, if the engine speed difference is lower than zero, the estimation will increase the engine speed. Means for controlling an engagement between a pinion of the tandem solenoid starter and an engine flywheel gear are configured so that if the engine speed difference is lower than zero, the estimation will increase the engine speed. An advantage of this aspect is to detect engine back-rotations and consequently estimate the proper speed at the time of engagement, by increasing the actual engine speed from a negative value (back-rotation) to a positive value.

According to a further embodiment, if the estimation of the engine speed at the time of engagement is in the range between 180 and 400 rpm, the motor of the tandem solenoid starter is spun and when its speed is higher than the engine speed of about 100 rpm, the pinion of the tandem solenoid starter engages the engine flywheel gear. The apparatus further includes means for spinning the motor of the tandem solenoid starter and means for engaging the pinion of the tandem solenoid starter with the engine flywheel gear, when the speed of the tandem solenoid starter is higher than the engine speed of about 100 rpm. An advantage of this embodiment is to recognize when the speed-match strategy between starter and engine must take place.

According to another embodiment, if the estimation of the engine speed at the time of engagement is lower than 180 rpm and no rock-back condition is detected, the pinion of the tandem solenoid starter engages the engine flywheel gear and, after a waiting time, the motor of the tandem solenoid starter can be spun. If the estimation of the engine speed at the time of engagement is lower than 180 rpm, the apparatus further includes means for detecting a rock-back condition, and, if no rock-back condition is detected, the apparatus is configured to operate with the means for engaging the pinion of the tandem solenoid starter with the engine flywheel gear and, after a waiting time, to operate with the means for spinning the motor of the tandem solenoid starter. An advantage of this embodiment is to recognize when the early pinion strategy must take place.

The method according to one of its aspects can be carried out with the help of a computer program including a program-code for carrying out all the steps of the method described above, and in the form of computer program product including the computer program. The computer program product can be embedded in a control apparatus for an internal combustion engine, including an Electronic Control Unit (ECU), a data carrier associated to the ECU, and the computer program stored in a data carrier, so that the control apparatus defines the embodiments described in the same way as the method. In this case, when the control apparatus executes the computer program all the steps of the method described above are carried out.

### BRIEF DESCRIPTION OF THE DRAWINGS

The present disclosure will hereinafter be described in conjunction with the following drawing figures, wherein like numerals denote like elements.

FIG. 1 schematically represents a hybrid powertrain of a motor vehicle;

FIG. 2 shows in more details an internal combustion engine belonging to the hybrid powertrain of FIG. 1;

FIG. 3 is a section A-A of the internal combustion engine of FIG. 2;

FIG. 4 shows a graph of the engine speed as function of the time during an engine stop phase;

FIG. 5 is a flowchart of a method of controlling a tandem solenoid starter according to a first embodiment of the present disclosure;

FIG. 6 is a graph depicting a method for estimation of the engine speed, according to an alternative aspect of the present disclosure; and

FIG. 7 is a block diagram of the alternative embodiment of the method of controlling a tandem solenoid starter.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

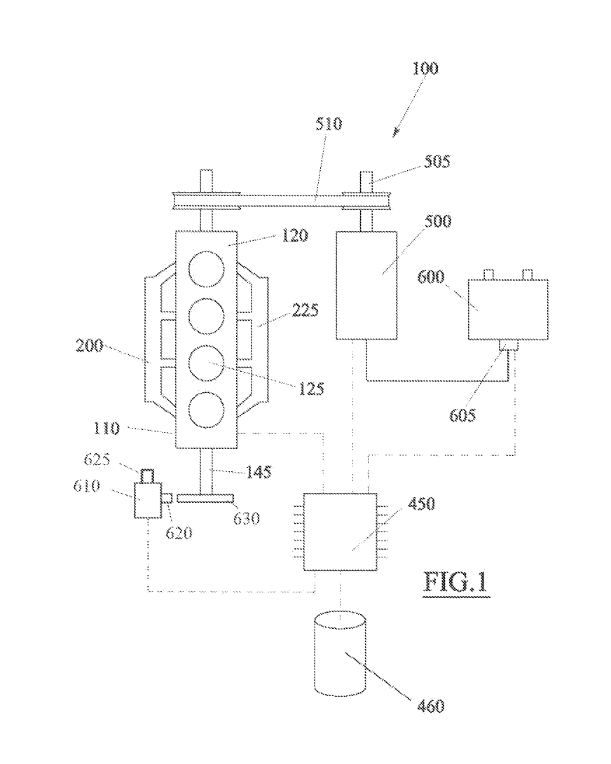

Some embodiments may include a hybrid powertrain 100 of a motor vehicle, as shown in FIG. 1, that includes an internal combustion engine (ICE) 110, in this example a diesel engine, a transmission (a manual transmission 510 in the example of FIG. 1), a motor-generator electric unit (MGU) 500, an electric energy storage device (battery) 600 electrically connected to the MGU 500, and an electronic control unit (ECU) 450. The hybrid powertrain architecture has at least a direct electric drive axle, the rear axle 520 in the example of FIG. 1.

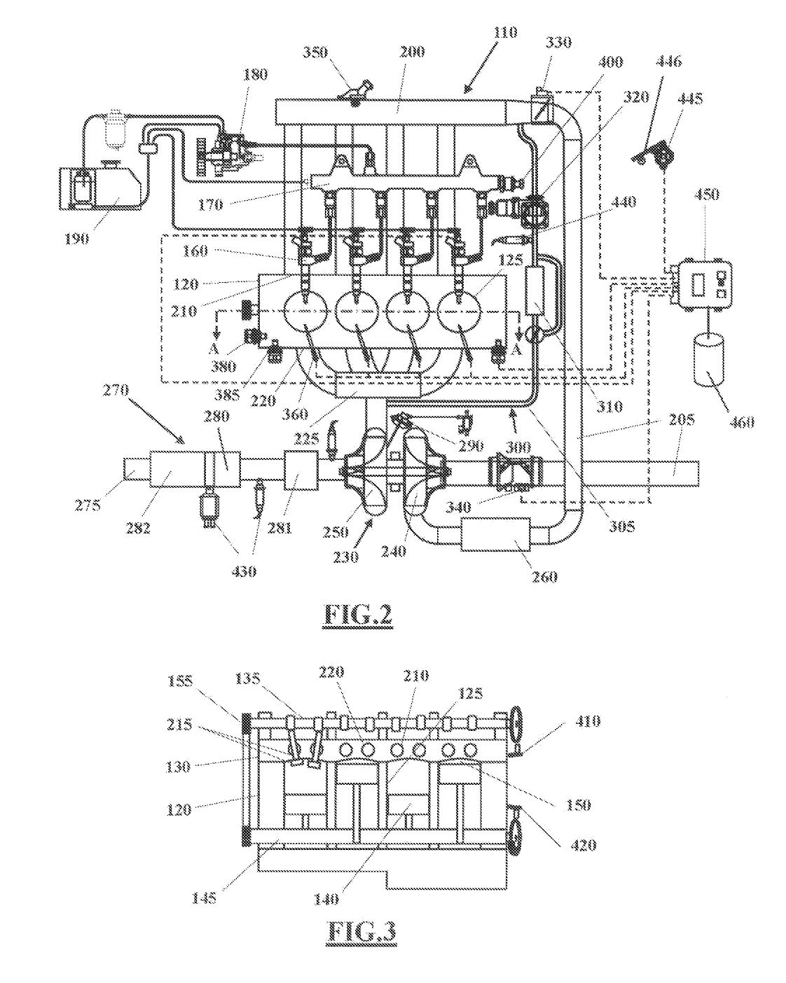

As shown in FIGS. 2 and 3, the ICE 110 has an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received from a fuel source 190.

Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270.

This example shows a 20 variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust after-treatment devices 280. The after-treatment devices may be any device configured to change the composition of the exhaust gases. Some examples of after-treatment devices 280 include, but are not limited to, catalytic converters (two and three way), oxidation catalysts, lean NOx traps, hydrocarbon absorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110 and equipped with a data carrier 40. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

The MGU 500 is an electric machine, namely an electro-mechanical energy converter, which is able either to convert electricity supplied by the battery 600 into mechanical power (i.e., to operate as an electric motor) or to convert mechanical power into electricity that charges the battery 600 (i.e., to operate as electric generator). In greater details, the MGU 500 may include a rotor, which is arranged to rotate with respect to a stator, in order to generate or respectively receive the mechanical power. The rotor may include means to generate a magnetic field and the stator may include electric windings connected to the battery 600, or vice versa. If the MGU 500 operates as electric motor, the battery 600 supplies electric currents in the electric windings, which interact with the magnetic field to set the rotor in rotation. Conversely, when the MGU 500 operates as electric generator, the rotation of the rotor causes a relative movement of the electric wiring in the magnetic field, which generates electrical currents in the electric windings. The MGU 500 may be of any known type, for example a permanent magnet machine, a brushed machine or an induction machine. The MGU 500 may also be either an asynchronous machine or a synchronous machine.

The rotor of the MGU 500 may include a coaxial shaft 505, which is mechanically connected with other components of the hybrid powertrain 100, so as to be able to deliver or receive mechanical power to and from the final drive of the motor vehicle. In this way, operating as an electric motor, the MGU 500 can assist or replace the ICE 110 in propelling the motor vehicle, whereas operating as an electric generator, especially when the motor vehicle is braking, the MGU 500 can charge the battery 600. In the present example, the MGU shaft 505 is connected with the ICE crankshaft 145 through a transmission belt 510, similarly to a conventional alternator starter. In order to switch between the motor operating mode and the generator operating mode, the MGU 500 may be equipped with an appropriate internal control system.

The automotive system 100 may further include an electronic control unit (ECU) 450 in communication with one or more sensors and/or devices associated with the ICE 110 and equipped with a memory system 460. The ECU 450 may receive input signals from various sensors configured to generate the signals in proportion to various physical parameters associated with the ICE 110 and the MGU 500. Turning now to the ECU 450, this apparatus may include a digital central processing unit (CPU) in communication with the memory system 460 and an interface bus. The memory system 460 may include various storage types including optical storage, magnetic storage, solid state storage, and other non-volatile memory. The interface bus may be configured to send, receive, and modulate analog and/or digital signals to/from the various sensors and control devices. The CPU is configured to execute instructions stored as a program in the memory system 460, and send and receive signals to/from the interface bus. The program may embody the methods disclosed herein, allowing the CPU to carryout out the steps of such methods and control the ICE 110 and the MGU 500.

In order to carry out these methods, the ECU 450 is in communication with one or more sensors and/or devices associated with the ICE 110, the MGU 500 and the battery 600. The ECU 450 may receive input signals from various sensors configured to generate the signals in proportion to various physical parameters associated with the ICE 110, the MGU 500 and the battery 600. The sensors include, but are not limited to, a mass airflow and temperature sensor 340, a manifold pressure and temperature sensor 350, a combustion pressure sensor 360, coolant temperature sensor 385, oil temperature sensor 385, a fuel rail pressure sensor 400, a camshaft position sensor 410, a crankshaft position sensor 420, exhaust pressure and temperature sensors 430, an EGR temperature sensor 440, a sensor 445 of a position of an accelerator pedal 446, and a measuring circuit capable of sensing the state of charge of the battery 600. Furthermore, the ECU 450 may generate output signals to various control devices that are arranged to control the operation of the ICE 110 and the MGU 500, including, but not limited to, the fuel injectors 160, the throttle body 330, the EGR Valve 320, the VGT actuator 290, the cam phaser 155, and the above mentioned internal control system of the MGU 500. Note, dashed lines are used to indicate communication between the ECU 450 and the various sensors and devices, but some are omitted for clarity.

The program stored in the memory system is transmitted from outside via a cable or in a wireless fashion. Outside the automotive system 100 it is normally visible as a computer program product, which is also called computer readable medium or machine readable medium in the art, and which should be understood to be a computer program code residing on a carrier, the carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulation technique such as QPSK for digital data, such that binary data representing the computer program code is impressed on the transitory electromagnetic signal. Such signals are e.g. made use of when transmitting computer program code in a wireless fashion via a WiFi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 450, the automotive system 100 may have a different type of processor to provide the electronic logic, e.g. an embedded controller, an onboard computer, or any processing module that might be deployed in the vehicle.

As known, an electric starter motor is the most common type used on gasoline engines and small Diesel engines. The modern starter motor is either a permanent-magnet or a series-parallel wound direct current electric motor with a starter solenoid (similar to a relay) mounted on it. When current from the starting battery is applied to the solenoid, the solenoid engages a lever that pushes out the drive pinion on the starter driveshaft and meshes the pinion with the starter ring gear on the flywheel of the engine.

As mentioned, in case of vehicles provided with a Stop & Start function, a tandem solenoid starter (TSS) 610 is used. This starter 610 is provided with a mechanism to separately control the forward slide of its pinion 620 and energize the motor. In this system, sliding the pinion gear forward according to engine speed and energizing the motor can be controlled independently, thus allowing the pinion gear to engage the engine flywheel gear 630 while the engine is still rotating.

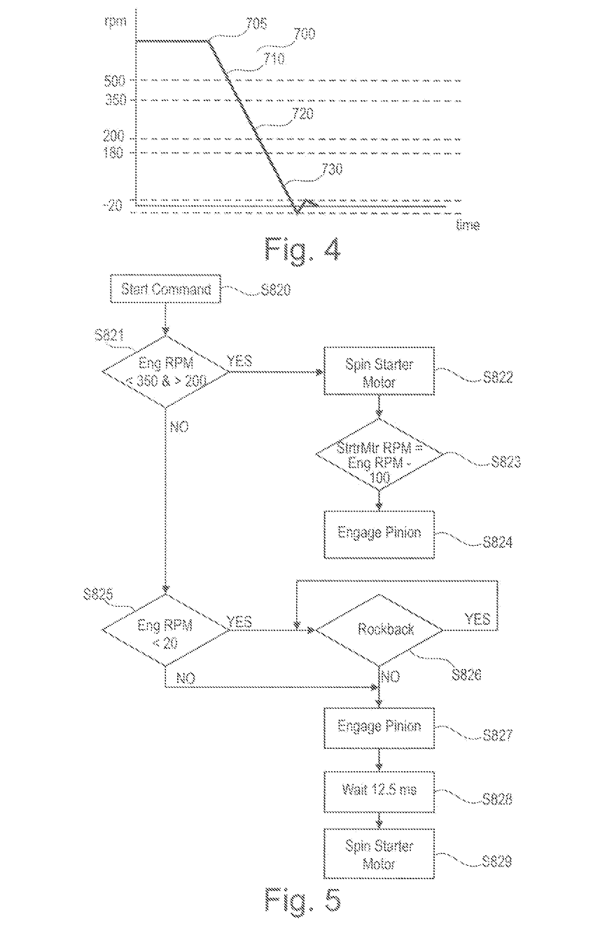

With reference to FIGS. 4 and 5, the strategy to control the TSS, according to a first embodiment, will now be explained. FIG. 4 shows a graph of the engine speed 700 as function of the time during a stop phase (or “autostop”), which starts in 705. FIG. 5 is a flowchart of the tandem solenoid starter 610 strategy. The change of mind, i.e. the driver request S820 to start the engine (autostart) while the engine is still running can happen at whatever engine speed. Therefore, three basic modes have been identified. In a first mode 710, the autostart is requested when the engine speed is higher than a threshold, for example 500 rpm. This case is out of scope of the present disclosure, since no starter cranking is required, but the ECU shall only provide to refuel the engine. In case the engine speed is between two thresholds, in the example between 350 and 500 rpm. This can be considered as a first transition zone and it will be helpful to wait until the engine speed becomes lower than 350 rpm. Second mode 720 happens if the engine speed is between two other thresholds, for instance between 200 and 350 rpm (S821). In this case, the TSS motor 625 is spun (S822) and when the engine speed is equal to the TSS motor speed (S823), the pinion 620 of the tandem solenoid starter engages (S824) the engine flywheel gear 630. The reason of such a range is due to the fact that, speed matching can occur up to crank speed plus a certain speed threshold (for example 180 rpm), but the TSS cannot apply torque above its cranking speed. Therefore, a speed of about 350 rpm allows enough time for the TSS to reach full speed without wasting energy. In case the engine speed is between 180 and 200 rpm, this is a second transition zone and it will be helpful to wait the engine speed becomes lower than 180 rpm. Third mode 730 is verified if the engine speed is greater than 20 rpm (S825) and less than 180 rpm. In this case, the pinion 620 can be early engaged (S827) and after a waiting time of about 12.5 ms (S828), the TSS motor 625 can be spun S829. The waiting time avoids contemporary pinion engagement and motor start, which would create some undesired noise. In case the engine speed is lower than 20 rpm (S825) a further check must be performed to determine if the engine is back-rotating, i.e. if a rock-back condition is detected (S826), then the pinion 620 and the TSS motor 625 should be inhibited.

However, according to this embodiment, it is not possible to ensure that, in case of speed-match (mode 2), the difference between the engine speed and the TSS motor speed would be less than a certain threshold (for example, 180 rpm) and positive. This control strategy is based only on current engine speed and assumes that the deceleration of the engine speed is known and constant. The engine speed at the time of engagement is estimated using only the time interval between the logic command to the TSS and the real pinion engagement. Furthermore, this embodiment cannot ensure that, in case of speed-pinion (mode 3), the pinion engagement would not occur during the engine back-rotation.

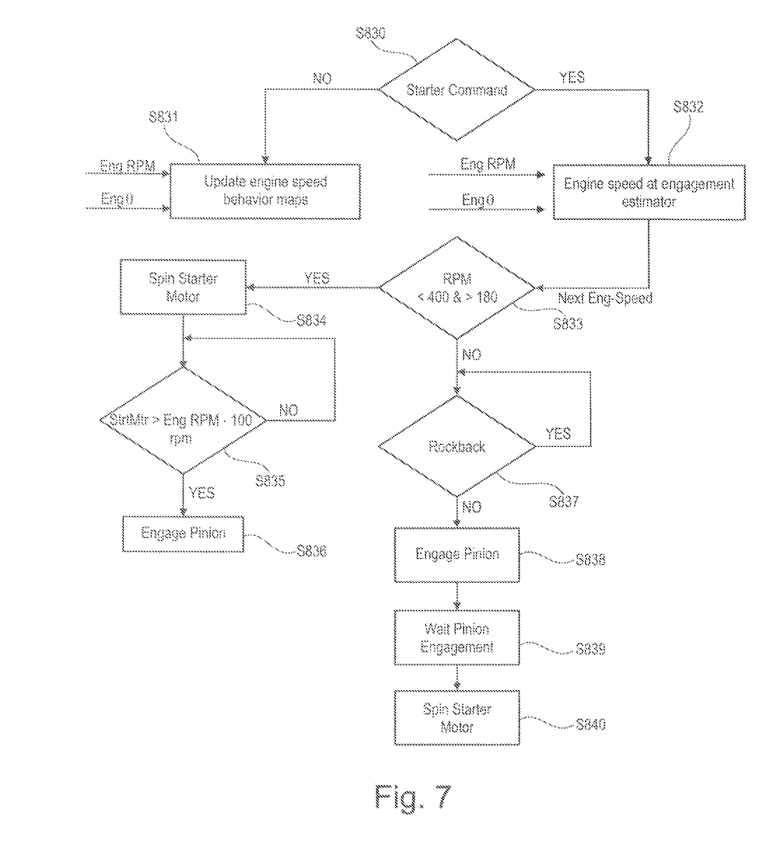

According to an alternative and preferred embodiment, the strategy for controlling the tandem solenoid starter is based on the estimation (S832 in FIG. 7), in a very reliable way of the engine speed at the time of engagement between a pinion 620 of the tandem solenoid starter 610 and an engine flywheel gear 630 as a function of a current engine speed and a current angular position of the engine crankshaft. This can be done, taking into account that, from the tandem solenoid starter requirements, the difference between the engine speed and the starter-motor speed at the time of engagement must be positive and lower than a certain speed threshold (for example, as already mentioned, 180 rpm). The TSS 18 motor depends on the battery voltage, the ambient temperature and the ageing of electrical components. The tolerance on predicting it is around ±30 rpm. Using 20 rpm, as a minimum difference between engine and motor speed at the time of engagement as a safe margin, the minimum tolerance accepted to predict the engine speed is ±50 rpm.

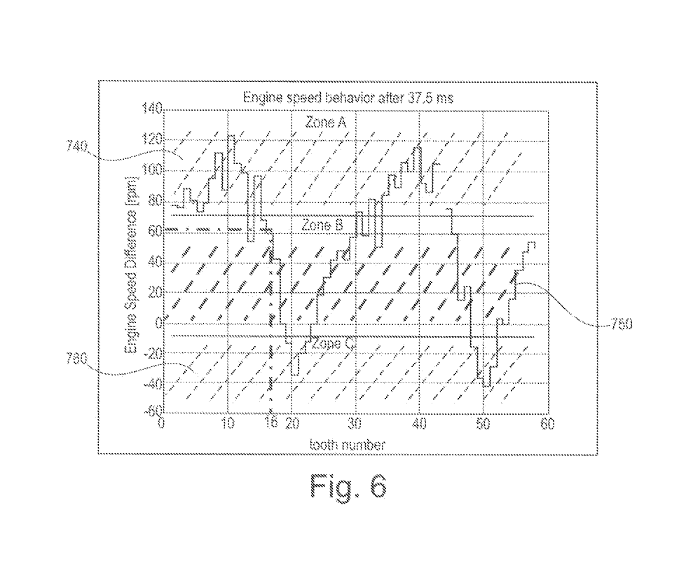

In order to predict the engine speed at the time of engagement, the angular position of the engine crankshaft at least every 12.5 ms (time of ECU change of mind logic calculation) should be known. Therefore, in FIG. 6 the engine speed at the time of engagement of the pinion can be estimated as a function of the angular position of the engine crankshaft (the wheel on the engine crankshaft has normally a number of teeth 10 equal to 60, that is to say, 6 degrees every tooth) and of the current engine speed. Such estimation will be performed after a calibrated time threshold t1 (for example, 37.5 ms) and with a resolution lower than 50 rpm, which is the accepted engine speed tolerance.

The graph in FIG. 6 is an example for a given engine speed and shows as X-axis the angular position of the engine crankshaft and as Y-axis the engine speed difference after 37.5 ms. The graph can be divided into three zones 740, 750, 760. If the point on the graph lies in the first zone 740, called Zone A, the engine speed difference will be higher than a calibrated speed threshold n1 and the estimation will provide an engine speed which will decrease more than such calibrated speed threshold. If the point on the graph is in the second zone 750, called Zone B, the engine speed difference will be lower than the calibrated speed threshold n1 and the estimation will provide an engine speed which will decrease less than the threshold n1. From experimental tests, the threshold can be assumed equal to 70 rpm. Finally, if the point on the map is in the third zone 760, called Zone C in the graph, the engine speed difference will be lower than zero and the estimation will provide an engine speed which will increase (this is the zone in which the engine is back rotating). As an example, assume that the graph in FIG. 6 refers to an engine speed of 350 rpm and that, when the speed estimation is performed, the tooth number is 16. Then, from the graph (see the thick dotted lines) the engine speed difference would be 60 rpm and consequently the engine speed at the time of the pinion engagement will be 350−60=290 rpm.

With continued reference to FIG. 7, after having performed the engine speed estimation, the present method will go on as follows. If the engine speed prediction (S833) is in the range between 180 and 400 rpm, the tandem solenoid starter motor 625 is spun (S834) and when its speed is higher than the engine speed of about 100 rpm (S835), the tandem solenoid starter pinion engages (S836) the engine flywheel gear 630.

On the contrary, if the engine speed prediction (S833) is lower than 180 rpm and no rock-back condition is detected (S837), the tandem solenoid starter pinion 620 is engaged (S838) and, after a waiting time (S839), the tandem solenoid starter motor 625 can be spun (S840). Of course, as in the known strategy, in case of engine back-rotation and until this condition is detected, the pinion engagement must be inhibited.

Advantageously, the map for predicting the engine speed at the time of the pinion engagement can be updated and consolidated whenever no autostart is required.

Summarizing, the present method allows the following benefits: first of all is very robust with respect to the actual strategy. Moreover, it allows a reduction of the engine start time and always avoids pinion engagement during back-rotation, in case of change of mind maneuver.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

1-10. (canceled)

11. A method of controlling a tandem solenoid starter for an automotive system having an internal combustion engine and a controller configured to automatically stop and start the internal combustion engine, the method comprising:
initiating a start of the internal combustion engine; and
engaging a pinion of a tandem solenoid starter and an engine flywheel gear on the basis of an engine speed estimation at the time of engagement when an engine speed is greater than zero; and
wherein said engine speed estimation is a function of a current engine speed and a current angular position of a crankshaft of the engine.

12. The method according to claim 11, wherein the engine speed is estimated on the basis of an engine speed difference with respect to the current engine speed after a time threshold (t1), said engine speed difference being a function of the current angular position of the engine crankshaft, and wherein said estimation is based on a resolution lower than a predetermined engine speed.

13. The method according to claim 12, wherein said predetermined engine speed is 50 rpm.

14. The method according to claim 12, wherein said estimation will decrease the engine speed more than said speed threshold (n1) when the engine speed difference is higher than a speed threshold (n1), and wherein said estimation will decrease the engine speed less than said speed threshold (n1) when the engine speed difference is lower than said speed threshold (n1).

15. The method according to claim 14, wherein said speed threshold (n1) is 70 rpm.

15. The method according to claim 12, wherein said estimation will increase the engine speed when the engine speed difference is less than zero.

16. The method according to claim 11, further comprising:
spinning a motor of the tandem solenoid starter when said estimation of the engine speed at the time of engagement is in the range between 180 and 400 rpm; and
engaging the pinion of the tandem solenoid starter and the engine flywheel gear when the engine speed is greater than about 100 rpm.

17. The method according to claim 11, further comprising:
detecting a no rock-back condition;
engaging the pinion of the tandem solenoid starter and the engine flywheel gear when said estimation of the engine speed at the time of engagement is lower than 180 rpm and a no rock-back condition is detected; and
spinning the motor of the tandem solenoid starter after a waiting time.

18. A non-transitory computer program comprising a computer-code suitable for executed on the controller for performing the method according to claim 11.

19. Computer program product on which the non-transitory computer program according to claim 18 is stored.

20. Control apparatus for an internal combustion engine, comprising an Electronic Control Unit, a memory system associated to the Electronic Control Unit and a non-transitory computer program according to claim 18 stored in the memory system.
